(19) United States
(12) Patent Application Publication
(10) Pub. No.: US 2022/0008922 A1
(43) Pub. Date: Jan. 13, 2022

(54) SAMPLING DEVICE AND SYSTEMS

(71) Applicant: LumaCyte, LLC, Charlottesville, VA (US)

(72) Inventors: Sean Hart, Keswick, VA (US); Colin Hebert, Charlottesville, VA (US)

(21) Appl. No.: 17/370,457

(22) Filed: Jul. 8, 2021

Related U.S. Application Data
(60) Provisional application No. 63/049,499, filed on Jul. 8, 2020.

(51) Int. Cl. B01L 3/00; G01N 35/10

(52) U.S. Cl. CPC B01L 3/502715; B01L 3/50273; G01N 2035/00346; G01N 35/1002; B01L 3/502784

(57) ABSTRACT

Provided herein are devices, systems, and methods of using the same, that enable manual and automated sampling and preparation of biological samples for assessment. The samples may be obtained in any quantity, including nano/micro/millifluidic amounts. The samples comprise cells and/or other biological particles that are in suspension or grown on substrates such as microcarriers, and may be obtained from one or more containers, such as single well plates, vials, flasks or bioreactors. The instrument to which the sample is transferred may comprise any analytical instrument, such as an optical force or laser force cytology instrument.

### CROSS-REFERENCE TO RELATED APPLICATIONS

This application claims priority to U.S. Provisional Patent Application Ser. No. 63/049,499 filed on Jul. 8, 2020, which is incorporated herein in its entirety.

### FIELD OF THE INVENTION

Embodiments of the present disclosure relate to devices, systems, and methods of using the same, that enable manual and automated sampling of any quantity, including nano/micro/millifluidic sampling. The samples are obtained from one or more containers, prepared for assessment and transferred to a separate instrument for analysis. The containers may comprise vessels ranging from a single well or vial, to a flask, bioreactor, or other vessel. The samples may comprise cells and/or other biological particles that may be in suspension or grown on substrates such as microcarriers. The instrument to which the sample is transferred may comprise any analytical instrument, such as an optical force or laser force cytology instrument.

### BACKGROUND OF THE INVENTION

In biopharmaceutical analysis, compositions of biological samples can be complex. Due to the diversity of biological matrices, the analysis of target substances in these samples presents significant challenges to sample processing. Samples often contain a large number of interfering substances in addition to the analytes, including endogenous substances, metabolites, and contaminants. An ideal sample pretreatment technique should maximally remove interfering substances and be suitable to a wide range of samples and for use with a wide range of analytical machines. Most samples must be properly processed for separation, purification, enrichment and chemical modification to meet the requirements of analytical instruments, such as Laser Force Cytology (LFC) analytical instruments, high performance liquid chromatography (HPLC), mass spectrometry (MS) machines, among others. Currently used methods are complicated, labor-intensive, prone to error and in some circumstances, may even be detrimental to the environment or hazardous to the technician. Current methods have many other shortcomings including a requirement for a large number of reagents, high testing costs and are further complicated with low recovery and sub-par precision. In addition, these methods are not conducive to on-line processing and automation.

What is needed therefore, are efficient devices, systems and methods for obtaining biological samples, and processing and preparing such samples for use with analytical instruments. Preferably such devices, systems and methods should be easy to implement, low cost, efficient, reliable and compatible with instruments such as laser force cytology instruments.

### SUMMARY OF THE INVENTION

Systems, methods and devices for preparing a sample for analysis comprising obtaining the sample from a vessel, processing the sample, and transporting the sample to an analysis instrument, wherein the system comprises a sample extraction apparatus, one or more control valves, one or more dilution apparatuses, one or more mixing apparatuses, and an analysis instrument interface are provided herein. In an embodiment, the analysis instrument comprises a RADIANCE® machine.

In certain embodiments, the invention further comprises a microcarrier separation device, wherein the microcarrier separation device is capable of separating a biological particle from a microcarrier comprising the use of enzymatic, chemical, thermal, or mechanical methods. Additional features of the invention include processing the sample by separating biological particles from other sample components, purification, enrichment, chemical modification and decontamination.

### BRIEF DESCRIPTION OF THE DRAWINGS

FIG. 1 provides a schematic showing a general set-up comprising the novel sampling system of the invention: sample containing vessel (for example, a bioreactor, 100), sample extraction tube (for example a sterile dip tube, 102), control valve (104A), dilution apparatus (110), instrument interface (115) (i.e. microfluidic or millifluidic chip or fluidic manifold), and an analytical instrument (113). Also shown is a vessel for waste collection (112). A reservoir/container (106B) is included in FIG. 1, this reservoir/container may serve a variety of purposes, such as for example, holding a solution for processing (i.e. dilution or washing). In certain embodiments, the analytical instrument (113) is a RADIANCE® machine (LumaCyte, LLC. Virginia USA).

FIG. 2 provides a schematic showing a general set-up comprising the novel sampling system of the invention, further comprising a microcarrier separation device (119). A container (117) optionally contains microcarrier enzymatic/chemical solution.

FIGS. 3A-3c: Provide schematics showing a general set-up comprising the novel sampling system of the invention with segmented flow. FIG. 3A shows a general configuration for segmented flow, specifically showing a sampling step; FIG. 3B provides a configuration incorporating a decontamination step, FIG. 3C provides a configuration incorporating a feature wherein wash fluid or solution is introduced into the system from a separate vessel (106B).

FIG. 4 provides a multiplex system comprising a sampling system wherein samples are obtained from two bioreactors (100(i) and 100(ii)).

FIG. 5 provides an embodiment of the novel sampling system of the invention comprising one or more features enabling monitoring with feedback for process control using a control system (such as a monitoring system).

FIG. 6 provides an embodiment of the novel sampling system of the invention comprising a built-in dual bioreactor system demonstrating continuous production.

FIG. 7 provides an embodiment of the novel sampling system of the invention comprising a combined dilution apparatus and instrument interface.

FIG. 8 provides an embodiment of the novel sampling system of the invention comprising a combined dilution apparatus and instrument interface allowing for non-segmented, continuous flow and rapid sample preparation, FIG. 8 specifically provides a set up using 4 all-in-one chambers.

FIG. 9 provides an embodiment of the novel sampling system of the invention comprising a separated dilution apparatus and instrument interface.

FIG. 10 provides a microfluidic T mixing and dilution device with microfluidic channels.

FIG. 11 provides a microfluidic T mixing and dilution device with microfluidic channels wherein the buffer channels are offset from one another at the mixing intersection.

FIG. 12 provides a schematic of an embodiment of the dilution apparatus wherein the dilution apparatus is a microfluidic multiplexor chip.

FIGS. 13A-G provides an embodiment of an instrument interface and also the sequence of steps for use thereof. FIG. 13A specifically provides a representative schematic wherein a sampling manifold dispenses into a well plate. FIG. 13A shows a diluted sample traveling from a dilution apparatus through a series of three valves, the middle of which is contained with a dispensing manifold (sampling manifold dispenses into a well plate), FIG. 13B shows an embodiment wherein the fluid stream from the dilution apparatus includes the cells to be introduced into the analytical instrument, FIG. 13C shows how a well plate moves to the injection location and that the motion platform incorporates a mechanism for vertical motion, FIG. 13D shows a top view that demonstrates how multiple manifolds can be positioned in order to enable multiple samples from multiple manifolds to be filled either in series (one sample at a time into the well plate from one manifold), or in parallel (multiple samples at the same time from multiple manifolds into one or more well plates), FIG. 13E shows an embodiment wherein the injection tubing is small enough to run through both the dispensing and injection manifolds, resulting in a direct flow path from the well plate to the analytical instrument, FIG. 13F shows an embodiment demonstrating a sequence for introducing cells detached from microcarriers into the analytical instrument, using a combined dispensing manifold and injection manifold, and FIG. 13G shows representative data collected on a RADIANCE® Laser Force Cytology instrument from a mixture of detached cells and microcarriers.

FIG. 14 provides a schematic of an embodiment of a device for removing microcarriers from cells.

FIGS. 15A-C provide schematics of embodiments of a device for removing microcarriers from cells: FIG. 15A provides an embodiment of a combined microcarrier removal device wherein the input of the device comprises microcarriers with cells or other bioproducts attached from a bioreactor or other source, the microcarriers enter a removal chamber where a substance used for detachment and/or anti-adhesion, is introduced via a separate input, the microcarriers then travel through a reaction zone in which the bioproduct separates from the microcarrier, FIG. 15B shows the settling of microcarriers and cells, FIG. 15C provides an embodiment showing multiple cell types separating based on difference in settling velocity.

FIG. 16 provides a schematic of an embodiment of a device for removing microcarriers from cells having a vertical design.

FIG. 17 provides a schematic of an embodiment of a device for removing microcarriers from cells.

FIG. 18 provides a schematic of an embodiment of a device for removing microcarriers from cells comprising the use of a laser to direct microcarriers down.

FIG. 19 provides a schematic of an embodiment of a device for removing microcarriers from cells. In certain embodiments, a detachment and separation mechanism as generally shown in FIG. 19 could be employed in order to detach cells (or biological particles) from microcarriers. The density gradient may be modified and customized to separate fluids (or density and phase)

FIG. 20 provides a schematic of an embodiment of a device for removing microcarriers from cells. In certain embodiments, the device is engineered and customized such that a difference in density and phase between the two layers as shown, create high density aqueous “plugs” or pockets such that cells can fall into them, but microcarriers cannot.

FIG. 21 provides a schematic of an embodiment of a device for removing microcarriers from cells.

FIG. 22 provides a schematic of an embodiment demonstrating non-spiral focusing method that may be used to separate the free cells (306) from microcarriers (304).

### DETAILED DESCRIPTION

The present invention is described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. One skilled in the art will recognize that the systems and devices of embodiments of the invention can be used with any of the methods of the invention and that any methods of the invention can be performed using any of the systems and devices of the invention. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as would be commonly understood or used by one of ordinary skill in the art encompassed by this technology and methodologies.

Texts and references mentioned herein are incorporated in their entirety, including PCT/US2017/068373, filed Dec. 23, 2017, and published as WO 2019/125502 A1 on Jun. 27, 2019, PCT/US2019/023130, filed Mar. 20, 2019, and published as WO 2019/183199 A1 on Sep. 26, 2019, PCT/US2019/026335, filed Apr. 8, 2019, and published as WO 2019/195836 A1 on Oct. 10, 2019, U.S. Provisional Patent Application Ser. No. 62/897,437 filed on Sep. 9, 2019, and U.S. Provisional Patent Application Ser. No. 63/049,499 filed on Jul. 8, 2020.

The novel invention provided herein comprises devices, systems, and methods of using the same, that enable manual and automated procurement and preparation of biological samples for assessment by analytical machines such as laser force analytical instruments and the like. The samples may be procured from any container, including, but not limited to bioreactors, and furthermore the samples may be procured in any quantity including nano/micro/millifluidic quantities.

The novel devices and systems provided herein, comprise one or more microfluidic sampling devices wherein a sample is taken from one or more bioreactors or other vessel(s) and subsequently introduced into an analytical instrument. As used herein, the term “bioreactor” is used interchangeably with the term “vessel” and can be understood to be include any container used for storing or processing cells (including culturing cells) such as flasks, bottles, test tubes, slides, bags, microtiter plates, microtiter dishes, multi-well plates, culture dishes, permeable supports and the like. The system may optionally include a variety of features and capacities that enable the preparation of samples for analysis. In an embodiment, the system provides a capability for diluting cells from a bioreactor with a specific buffer or fluid to achieve a desired concentration. The system may also optionally include the capability of detaching adherent cells growing on microcarriers or other suitable substrates and subsequently separating the suspended cells from the microcarriers prior to introduction into an analytical instrument.

The devices and systems contemplated herein comprise features that support processes which enable the flow of samples from one location to another. All fluids in all forms of embodiments that are discussed herein may be moved from one location to another by means of pressure or vacuum driven flow, pumping via a peristaltic pump, syringe pump, diaphragm pump, etc., whereby the direction of flow is determined by such forces, valve configurations, and tubing involved.

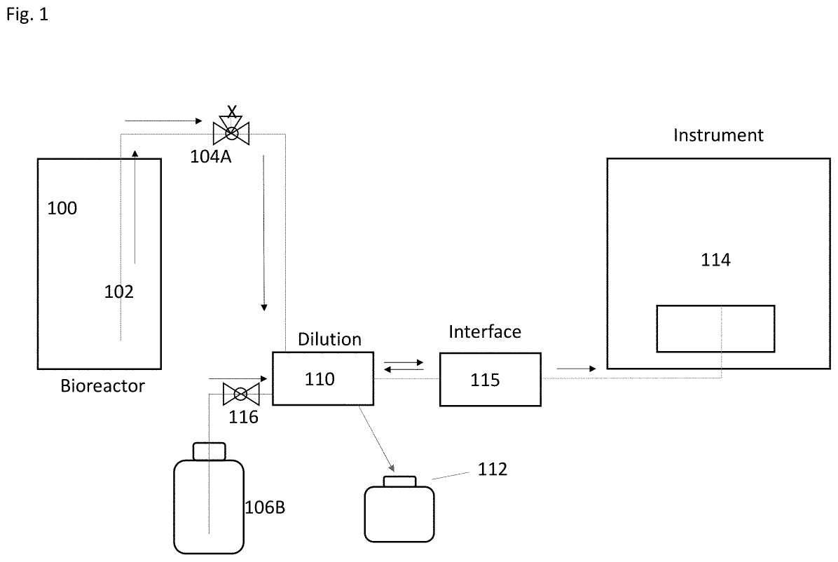

FIG. 1 provides one embodiment of the system. An extraction device for procuring the sample, such as a sterile dip tube (102) is placed in a bioreactor (100) in order for the system to access the sample. While sampling, fluid from the bioreactor is drawn up into the dip tube (102) and subsequently passes through a valve (104A) prior to flowing into the dilution apparatus (110). Solution used for dilution or reagent addition (106B) (if required) flows though valve (116) and into the dilution apparatus (110) in order to dilute the cells to a desired target concentration. The flow rate of (106B) can be modulated and customized according to methods known to those skilled in the art in order to achieve a range of target concentrations. The sample then travels to the instrument interface (115), which is designed to present the sample in a means that allows for facile and robust introduction into the analytical instrument (114). As indicated in FIG. 1 between (110) and (115), the system will have the ability to move reagents, buffers, and cleaning solutions in multiple directions. It is important to note that dilution apparatus (110) and the instrument interface (115) may be separate devices as shown in FIG. 1 or coupled together on a single combined device that performs both functions. Waste (112) can be ejected from either the dilution apparatus (110) as shown in FIG. 1, as well as from the instrument interface (115) as needed.

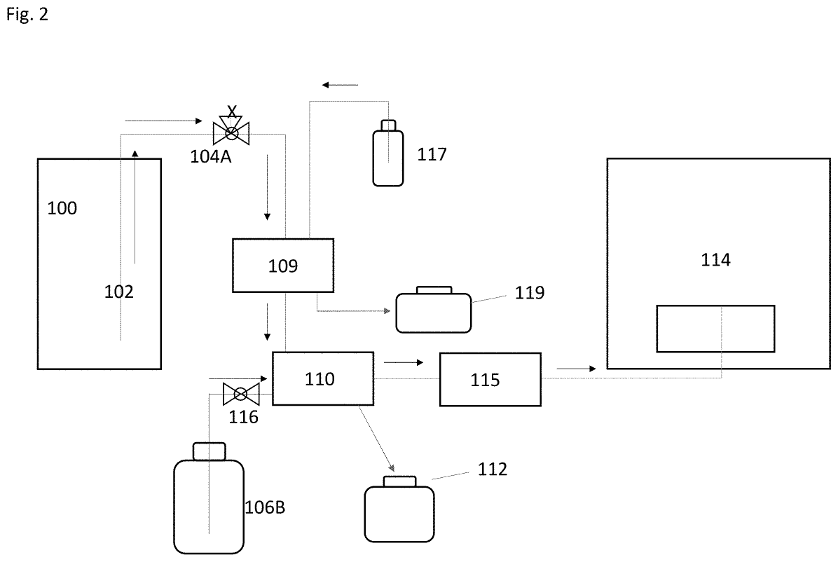

FIG. 2 shows the optional addition of a device to be used when adherent cells are growing on microcarriers within the bioreactor. In this embodiment, sample containing cells attached to microcarriers is removed from the bioreactor (100) and first introduced into the microcarrier separation device (109), which both detaches the cells from the microcarriers and separates the suspended cells and microcarriers into different fluidic streams. Microcarrier separation devices (that do not also perform the detachment step) are known to those skilled in the art and as used herein comprise all such devices that separate cells from other devices, and enable the separation of cells such that they are available for analytical purposes. Examples include the HARVESTAINER™ system (Thermo Fisher Scientific, Massachusetts, USA) and other filter based systems designed for large scale bulk separation of cells from microcarriers post-detachment. After processing, the detached cells continue onto the dilution apparatus (110), while the microcarriers exit the device and into waste (119). Cells may be separated from the microcarriers via several methods, including enzymatic, chemical, thermal, or mechanical methods. Chemical and enzymatic methods may require the addition of a solution (117), such as trypsin, ethylenediaminetetraacetic acid (EDTA), or other suitable enzymes or chemicals to the microcarrier separation device (109). Once the cells have been detached and separated from the microcarriers, the rest of the system functions as described above, with the sample flowing through the dilution apparatus (110) and then the instrument interface (115) prior to introduction to the analytical instrument (114). It is important to note that the microcarrier separation device (109), dilution apparatus (110), waste collection (112), and the instrument interface (115) may be separate devices as shown in FIG. 2 or coupled together into one combined device that performs all three functions or two devices that when used together perform all three functions.

The embodiments presented in FIGS. 1 and 2 allow for continuous sampling. This means that the system is constantly removing sample from the bioreactor (100) in order to prevent backflow and contamination. The volume removed is sufficiently low such as to not have a detrimental effect on the overall process and can be adjusted as needed depending upon the cell concentration, process design, and sampling regime. The valve (104A) is an actively controlled valve that can closed as needed or be a passive one-way check valve that only allows flow out of the bioreactor in order to further prevent backflow and contamination. Although only one valve is shown in the FIG. 1 and FIG. 2 embodiments, it is anticipated that multiple valves of one or more types including multi-port/multi-way valves may be employed at any point throughout the fluidic system as needed. The valve may be manually controlled, or automated via electronic or computerized mechanisms.

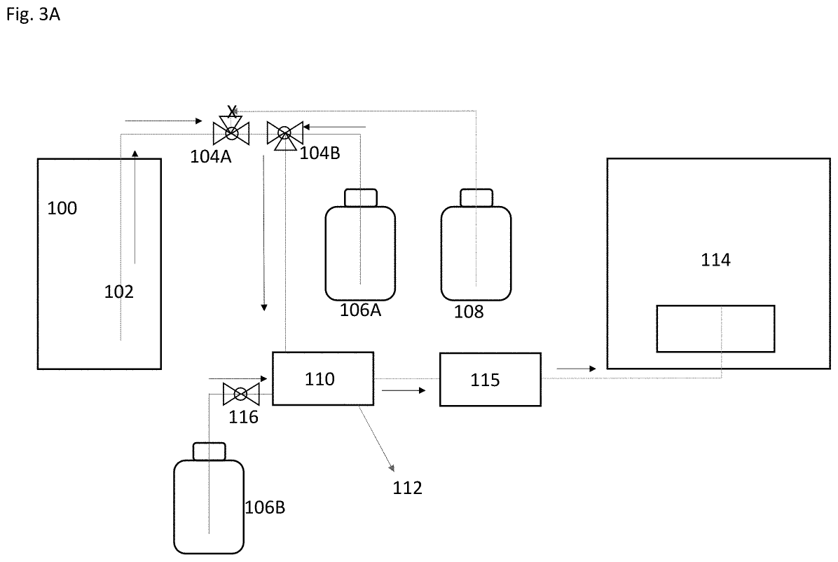

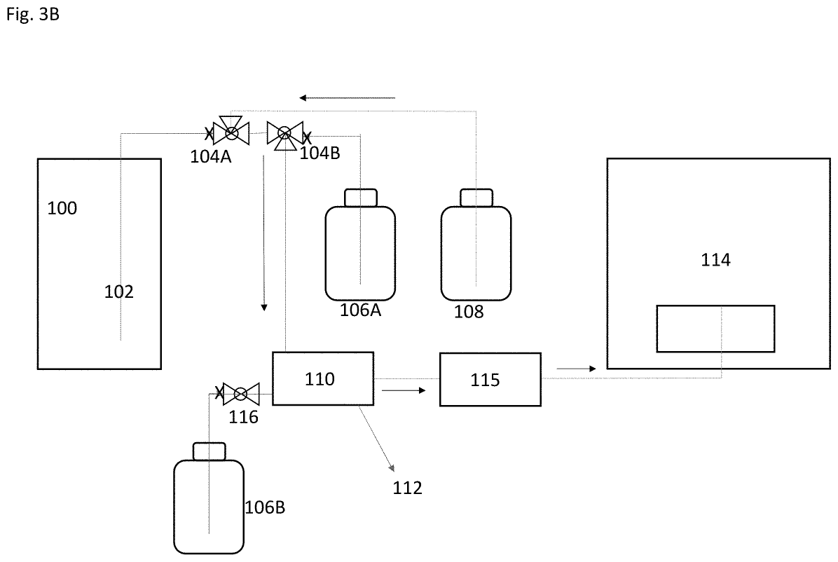

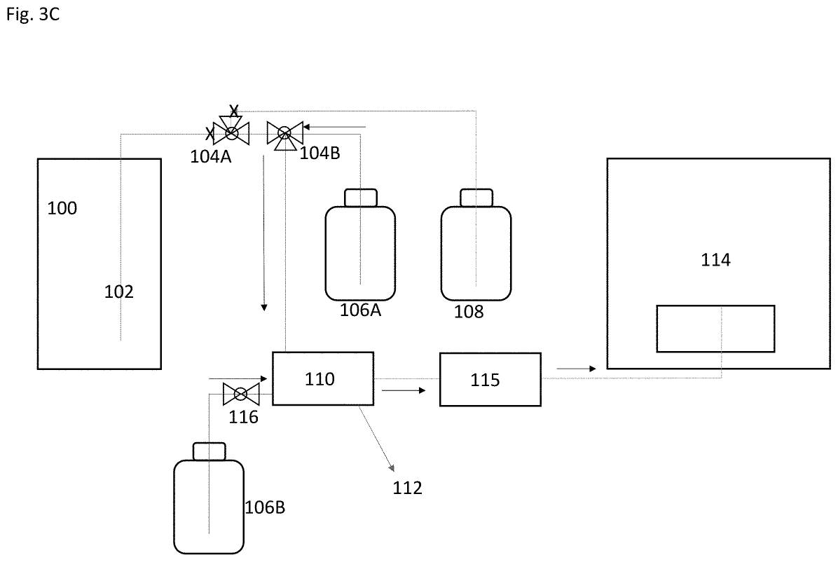

A segmented (as opposed to continuous) sampling regime is provided in FIGS. 3A, 3B, and 3C. In a sampling step, sample from the bioreactor is drawn up by the forces mentioned above and travels through a series of valves (104A and 104B). The first of the valves connects the decontamination fluid (108) to the sample line, allowing for cleaning post-sample analysis. In FIG. 3A, the valve is open for allowing sample through but closed to the decontamination fluid, ensuring that no decontamination fluid mixes with the sample. The sample then travels through valve 104B, wherein the sample comes in contact with a solution used for dilution (106A). In order to minimize the amount of sample taken from the bioreactor and to avoid sample settling in the tubing lines, the dilution solution in 106A is meant to drive the sample quickly to the dilution apparatus (110). Here, more solution (one or more types) used for dilution (106B) may be introduced to rapidly dilute sample to the appropriate concentration before entering the instrument interface (115) prior to introduction to the analytical instrument (114). Waste exits the dilution apparatus post-sample preparation (112). Although not shown in FIGS. 3A-3C, a segmented sampling regime can also be used with a microcarrier system that would also include the microcarrier separation device (109), as shown in FIG. 2.

FIG. 3B demonstrates the configuration for a decontamination step post-sample analysis. The first 3-way valve (104A) is open to the decontamination fluid but closed to the sample. The second 3-way valve (104B) is closed to the solution (106A) but open to allowing the decontamination through the line into the dilution apparatus (110). Valve (116) is also closed to prevent dilution of the decontamination fluid in the dilution apparatus. The decontamination fluid continues through the instrument interface (115) and into the injection port of the analysis instrument (114). In this system, the entire line is cleaned between each sample, thereby ensuring sample sterility and preventing contamination. When the entire line has been cleaned, waste (112) exits the dilution apparatus (110) or instrument interface (115).

FIG. 3C shows the wash step that follows FIG. 3B. In order to get the decontamination fluid (108) out of the line and the line prepared for the next sample, dilution fluid washes through the line. Valve 104A remains closed to the sample and is closed to the decontamination fluid. Valve 104B is opened so that solution from 106A is introduced to the line and enters the dilution apparatus (110). Valve 116 is also opened, allowing solution from 106B to enter the dilution apparatus, thoroughly washing the dilution apparatus for the next sample. The buffer fluid (106B) then goes through the instrument interface (115) and to the injection of the analysis instrument (114) to wash the line before exiting to the waste (112).

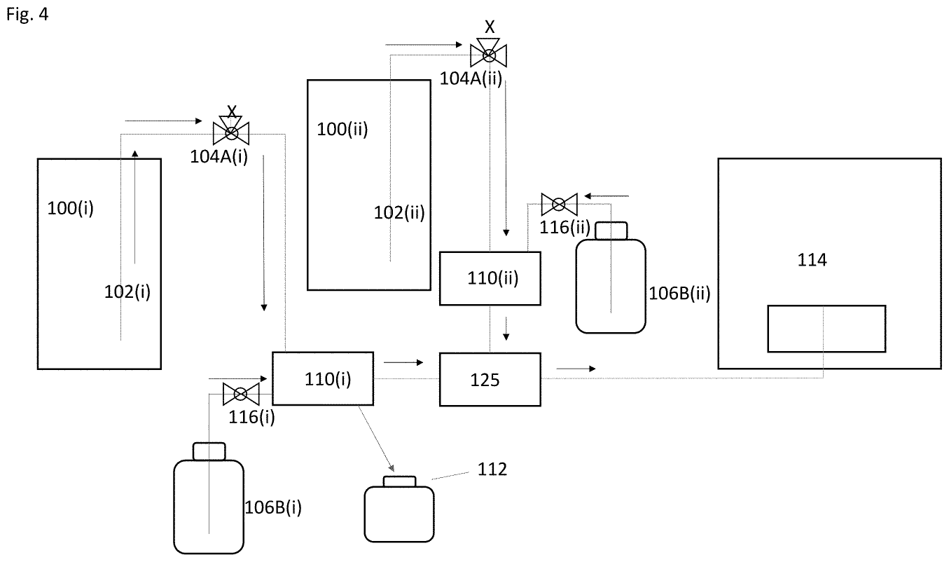

It should be noted that the embodiments designed to sample from multiple bioreactors can also be implemented using the concepts described above in FIGS. 1, 2, 3A, 3B, and 3C. One embodiment is shown in FIG. 4 where samples are obtained from two separate bioreactors (100(i) and 100(ii)) and introduced into the analytical instrument (114). In the embodiment shown, samples from each separate reactor flow to separate distinct dilution apparatuses (110(i) and 110(ii)) before combining into a multiplex instrument interface (125). The multiplex instrument interface (125) accepts flows from multiple inputs that are sequentially directed through the output and into the analytical instrument (114). The samples remain distinct as to allow precise sampling from each separate bioreactor (110). Specific designs to achieve this are described subsequently. Appropriate physical separation or cleaning steps are employed to keep the samples distinct and separated. Although 2 reactors are shown in FIG. 4, multiple reactors can be connected.

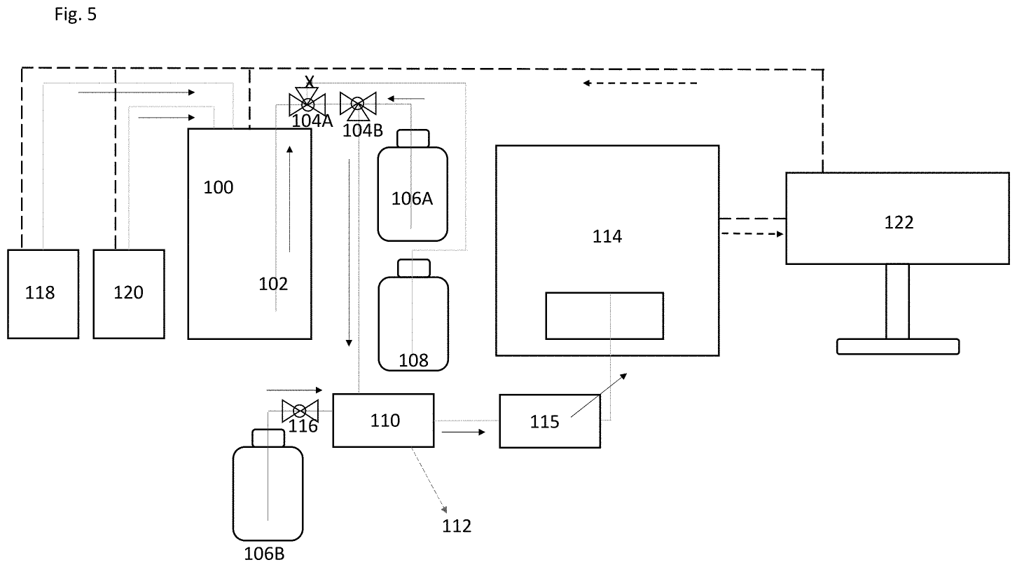

Additional features of the invention include earlier described embodiments and procedures in a continuous feedback monitoring system as shown in FIG. 5. In one embodiment, the conditions of the bioreactor (100) are maintained or adjusted by the varied introduction of input 1 (118) and input 2 (120), though any number of inputs can used in alternate embodiments. During operation, the analysis instrument (114) monitors the bioreactor's condition in order to adjust conditions within the bioreactor, which could involve adjusting the input flow from input 1 (118) and/or input 2 (120). In one embodiment, the measurements from the analysis instrument are then sent to a control system (122), which directs changes to the bioreactor (100) as needed. The control system comprises a monitoring component such as a computer that enables manual or automated adjustment of changes to or within the bioreactor based on data collected from one or more devices. These changes may include, but are not limited to, introduction of reagents or other solutions to introduce nutrients, adjustment of pH, modification of cell culture conditions, or change cellular state, as well as changes to gas concentration or sparging rate, temperature, or mixing speed. This aspect allows for real-time production line monitoring and adjustment, allowing the bioreactor to be operated in a more precise manner to increase production time, efficiency, quality, or any combination of thereof. Multiple bioproducts can be introduced and multiple bioreactors can be used in this set up. This setup can also be operated in batch, fed-batch, or continuous operating modes.

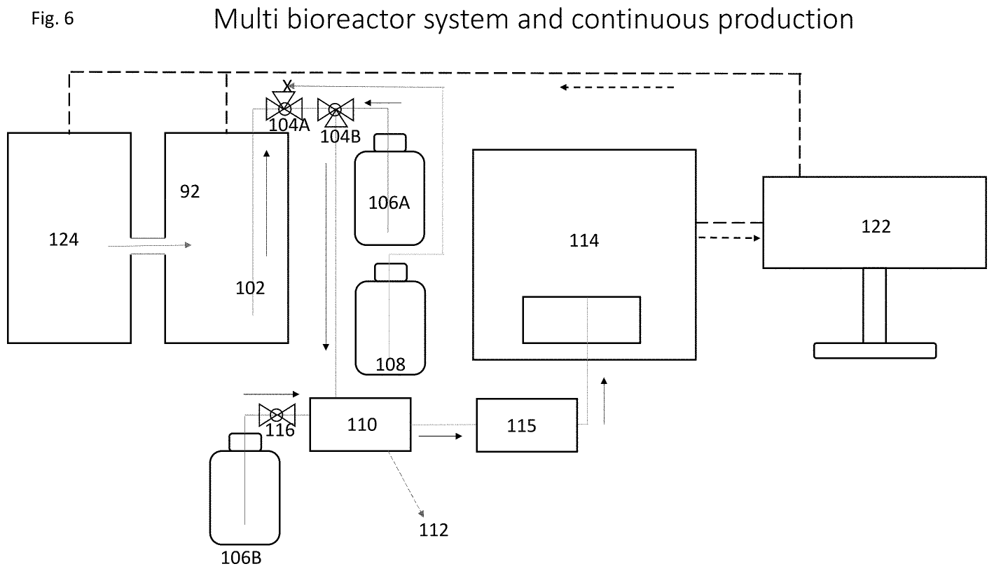

In an additional embodiment, the devices and systems further comprise a built-in dual bioreactor system. One embodiment is shown in FIG. 6, wherein a first bioreactor (124) serves as an input to a second bioreactor (92), to which the analytical instrument (114) is connected. During operation, analytical instrument (114) monitors the conditions within bioreactor (92) and any changes that occur. The measurements and information can then be sent to a computer (122) that communicates to the bioreactors in order to adjust their interaction with one another. The analysis instrument may be paired with-multiple bioreactors, with each one connecting to one source bioreactor (124) or with each connecting to its own discrete source bioreactor. Procedures of sampling, decontamination, and washing are similar to the steps described in detail previously. This setup can also be operated in batch, fed-batch, or continuous operating modes.

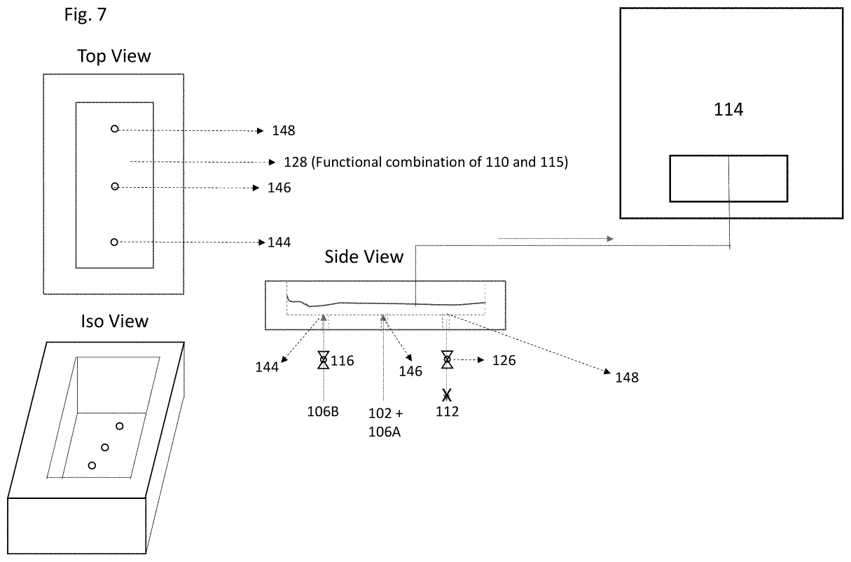

FIG. 7 presents one embodiment of a combined dilution apparatus (110) and instrument interface (115). It is an all-in-one chamber (128) with 3 ports at the base of the chamber. The dilution port (144) allows fluid from (106B) through 2-way valve (116) to fill the chamber for rapid dilution. The waste port (148) allows the fluid in the chamber to exit the chamber to waste (112). The injection port (146) allows the sample from the bioreactor (102) plus (if needed) the rapid movement buffer fluid (106A) to meet at valve 104B and enter into the chamber. During a sampling step, the waste valve (126) closes, preventing the fluid from leaving the chamber. The sample and dilution solution enter from their respective ports and fill up the chamber until the proper concentration is reached. Once the correct concentration is reached, the fluid then enters the analysis instrument (114), where the sample is analyzed for current bioreactor conditions. Post-analysis of the sample, the waste valve (126) opens, allowing for the remaining fluid to drain to waste. The waste valve is then closed once again, as well as the valve from the buffer solutions (FIG. 3A-C, 106A and B). Decontamination fluid (108) is drawn into the all-in-one chamber to fill the chamber, and then is drawn into the analysis instrument to clean and sterilize the lines in preparation for the next run. Left over decontamination fluid in the chamber drains to waste (112) by the opening of valve (126). Next, valve (126) closes again, the valves to the buffer fluids are opened, and the all-in-one chamber is filled with buffer to wash out the decontamination fluid. The buffer fluid then travels to the analysis instrument for a period of time before draining out of the all-in-one chamber via waste (112). The all-in-one chamber (128) can be shaped in various ways so long as it can contain the proper volume of fluid and diluted sample is able to leave the chamber and enter the analytical instrument (114).

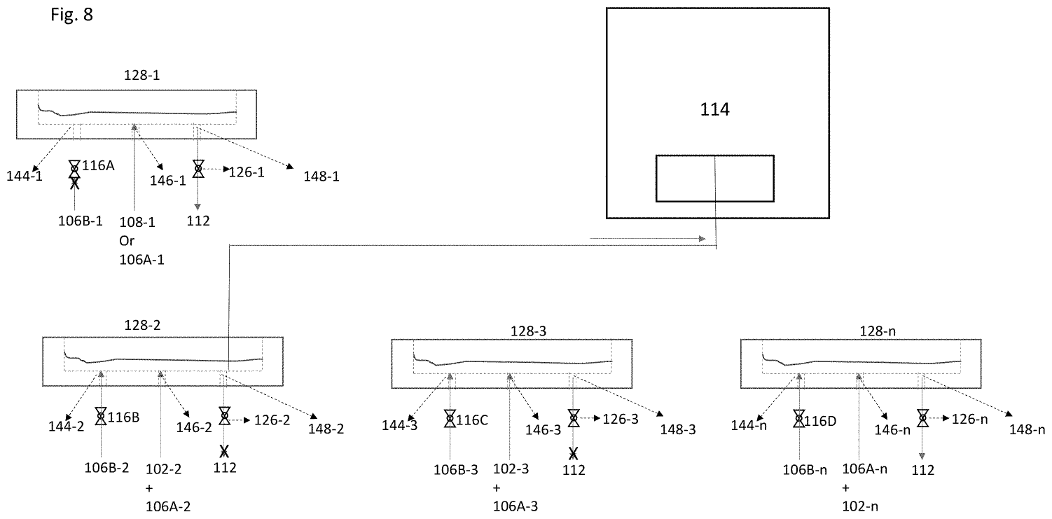

In a configuration using a multiple number of bioreactors, there are a corresponding number of all-in-one chambers (128), all of which can be housed on the same material or separated from each other as necessary. Each all-in-one chamber connects to its own bioreactor in such a way that FIG. 3A is repeated the corresponding number of times so that all bioreactors, valves, dilution apparatuses, and tubing arrive at one analysis instrument. Each bioreactor has its own set of fluids (106A, 106B, 108) to ensure sterility and efficiency of fluid movement. In the all-in-one chambers, each buffer port (144) connects to its own buffer (106B), each injection port (146) connects to its own bioreactor dip tube (102) and rapid movement buffer (106A) via its own 3-way valve (104B), and each waste port (148) leads to a communal waste (112). Such a configuration allows for non-segmented, continuous flow and rapid sample preparation, preventing wait time. FIG. 8 provides one embodiment of such a set up using 4 all-in-one chambers. In the depiction shown, the all-in-one chamber (128-2) is shown in the sampling step wherein the sample from the particular chamber is entering into the analysis instrument (114) for measurement. All-in-one chamber (128-1) represents the sample that was run prior to the one in (128-2). All-in-one chamber (128-1) is undergoing the decontamination and wash procedure as described above and shown in FIG. 3B. All-in-one chamber (128-3) is preparing for the analysis of the next sample. The waste valve (126-3) is closed and the buffers (106A-3 and 106B-3) along with the sample (102B-3) from bioreactor 3 enter into the all-in-one chamber. Proper dilution occurs while the sample before is running, so that when sample from (128-2) is done, the analysis instrument can immediately begin taking measurements from (128-3). All-in-one chamber (128-n) represents all other all-in-one chambers in the system. The waste (112-n) is open as well as the valves for buffers (106A-n) and (106B-n), allowing for constant flow through the all-in-one chamber. This constant flow procedure can be done for 1 to n bioreactors through the all-in-one chamber (128-n) and eliminates a break in the fluid flow, which maintains an acceptable environment for the sample to travel through. Constant flow of buffer also makes the use of decontamination fluid after each sample from a specific bioreactor optional, so as to increase sampling rate and to reduce the contact between sample and harsh environments. The decontamination fluid (108) can be used at the end of a bioreactor run to decontaminate the system. The sample is transported from each sampling chamber to the analysis instrument by connection mechanisms such as tubing and the like. In certain embodiments, connections are facilitated through the use of multi-port valves.

In the system that opts to flow buffer constantly and not use decontamination fluid until the end, sample from the bioreactor (100) can also be constantly drawn into its specific all-in-one chamber (128). Constantly drawing sample and keeping valves (104A) and (104B) open will ensure that between measurements of a specific bioreactor, none of the sample that has been drawn out of the dip tube (102) will fall back into the bioreactor, thereby contaminating the entire reactor. Using the fluid forces listed above, sample and buffer flow rates into all-in-one chambers not currently being sampled by the analysis instrument can be minimalized so as to not waste resources. All fluid flow rates can be variable so as to make real-time adjustments with precision and accuracy to ensure sampling integrity.

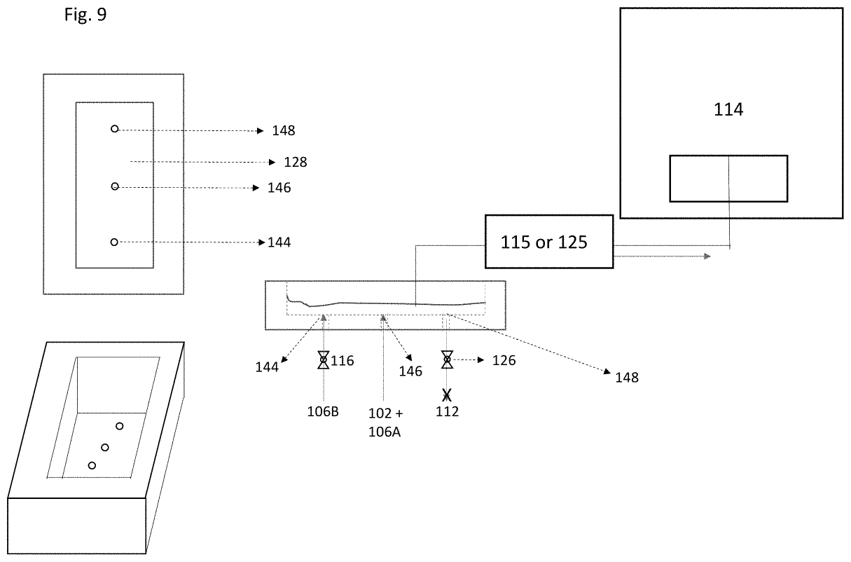

It is important to note that embodiments described in FIGS. 7 and 8 may also be used as a dilution apparatus (110), as opposed to a combined dilution apparatus (110) and instrument interface (115). When used as a dilution apparatus, the sample exits the dilution apparatus (110) and enters a separate instrument interface (115), prior to introduction to the analytical instrument (114). This interface may be used to perform other manipulations on the sample, including partitioning the sample using droplets or plugs or performing other manipulations as needed in order to properly interface with the analytical instrument. One embodiment of this is shown in FIG. 9.

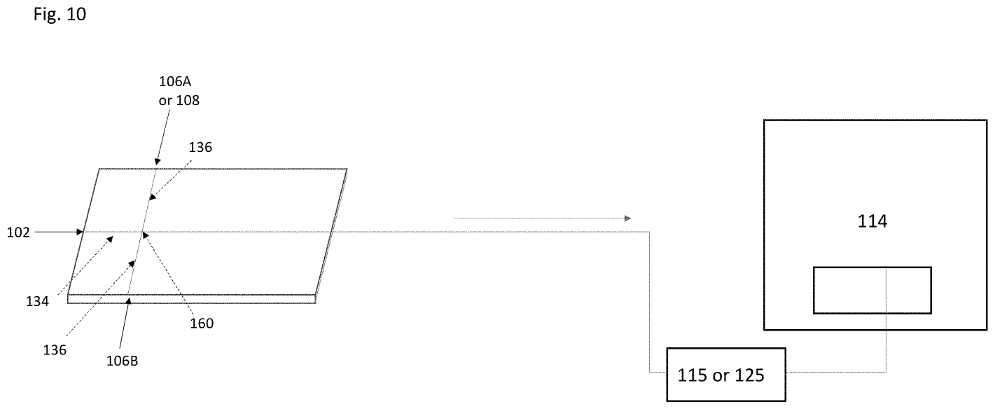

Another embodiment of the dilution apparatus (110) is shown in FIG. 10. FIG. 10 is a schematic showing a microfluidic T mixing and dilution device with microfluidic channels of any micro size and shape necessary for correct dilution to the proper sample concentration. In this figure, sample from the dip tube (102) enters onto the microfluidic T mixer through the sample introduction channel (134). As needed, the buffers (106A or 106B) used for rapid sample movement and dilution enter by the buffer channels on either side of the device (136) and collide (approximately) perpendicularly with the sample and in line with each other at the mixing intersection (160). The collision of a large volume of buffer and the smaller volume of sample at a right angle disrupts laminar flow paths, mixes, and dilutes the sample to the desirable concentration. The sample then flows either directly into the analytical instrument (114) or into the instrument interface (115) prior to entering the analytical instrument (114). The decontamination fluid (108) is listed as an optional source for one of the buffer channels (136) in order to demonstrate how decontamination fluid can enter the microfluidic T mixer to clean during the decontamination procedure described above.

For multiple bioreactors, either multiple microfluidic T mixers (FIG. 10) may be used in parallel or the microfluidic T mixer can have multiple sample introduction channels (134) that intersect at multiple buffer channels (136) at multiple mixing intersections (160).

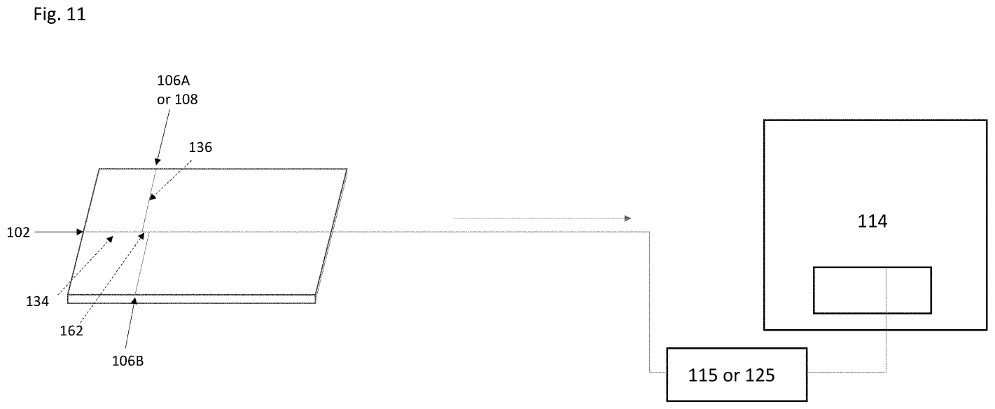

FIG. 11 shows another embodiment of a dilution apparatus (110). This microfluidic offset T mixer is similar to that in FIG. 10, but the buffer channels are offset from one another at the mixing intersection (162) by any distance close enough for the sample to experience rapid jostling to disrupt laminar flow lines. This configuration can ensure mixing and dilution at a potentially greater efficiency before the sample enters the analysis instrument (114). As with other configurations of the invention, the channels shown in FIG. 11 may be modified with respect to size, shape and placement depending on the nature of the sample being assessed, and depending on other considerations such as flow, analytical parameters and characteristics being evaluated.

For multiple bioreactors, either multiple microfluidic offset T mixers (10) may be used in parallel or the microfluidic offset T mixer can have multiple sample introduction channels (134) that intersect at multiple offset buffer channels (136) at multiple offset mixing intersections (162).

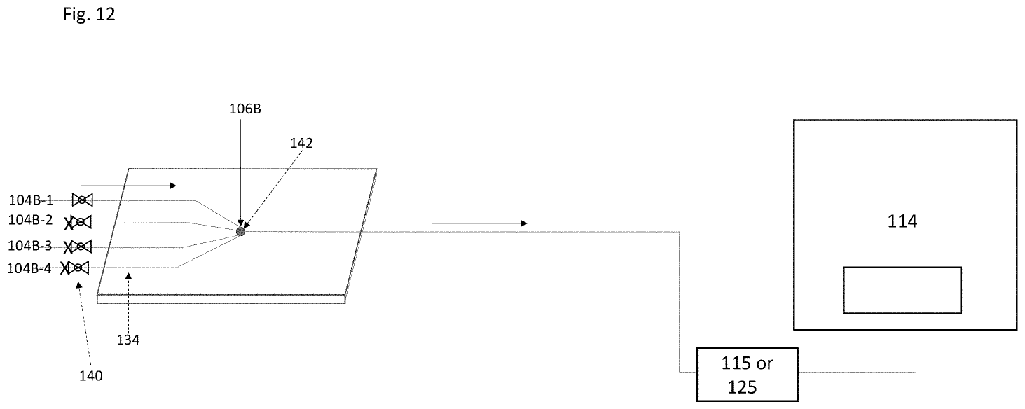

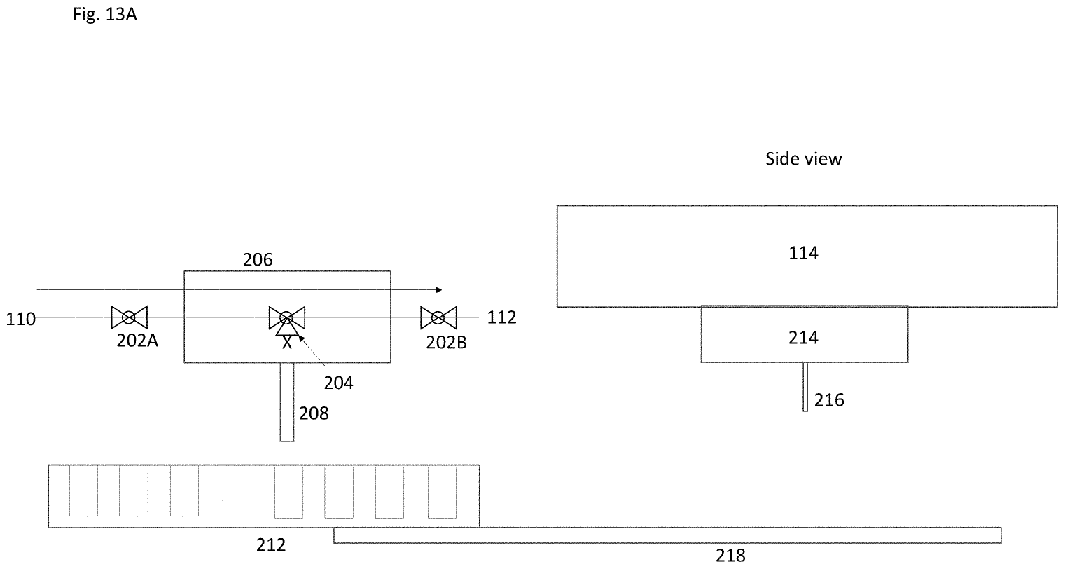

FIG. 12 shows another embodiment of the dilution apparatus (110), wherein the dilution apparatus is a microfluidic multiplexor chip. In this embodiment, the samples from multiple bioreactors enter onto the multiplexor chip via multiple sample introduction channels (134) that all converge to one mixing and dilution location (142). The source for the sample introduction channels is represented by valve (104B), since sample, buffer (106A), and decontamination fluid (108) all arrive to the chip via valve (104B). For bioreactors that are not currently sampling, corresponding chip introduction valves (140) are closed to prevent another sample from going backwards and contaminating other lines. The sample from one bioreactor is pushed onto the chip by buffer 106A and goes to the mixing and dilution location (142) where buffer from (106B) quickly enters through a port or buffer channel to dilute and mix the sample. The diluted sample then exits the multiplexor chip and then either enters the analytical instrument (114) directly for measurement or first enters the instrument interface (115) prior to introduction to the analytical instrument (114). Following the sample analysis, the decontamination and wash procedures described above, clean and prepare the multiplexor chip for the next sample by allowing correct fluids through the introduction channel (134).

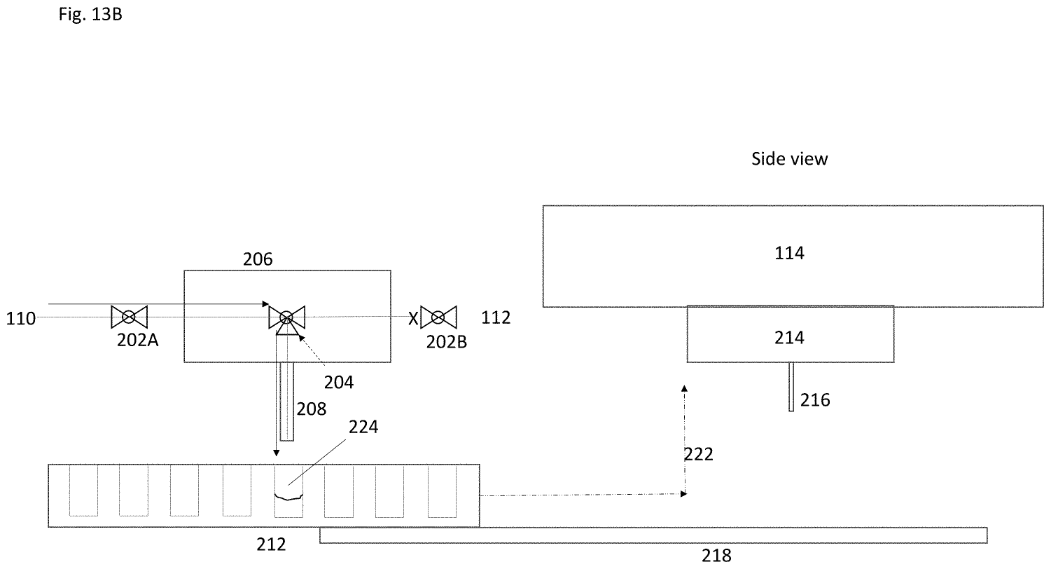

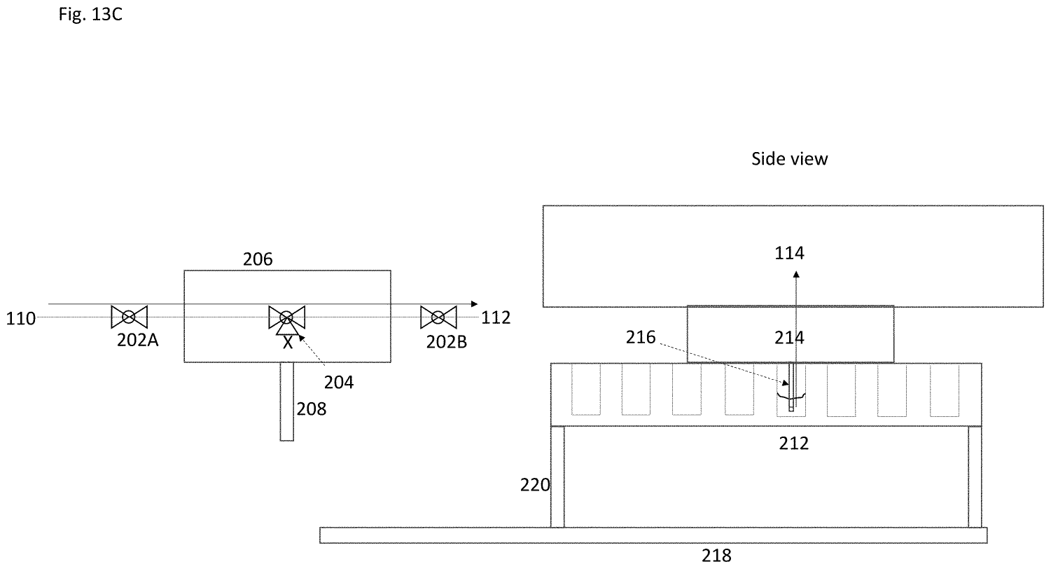

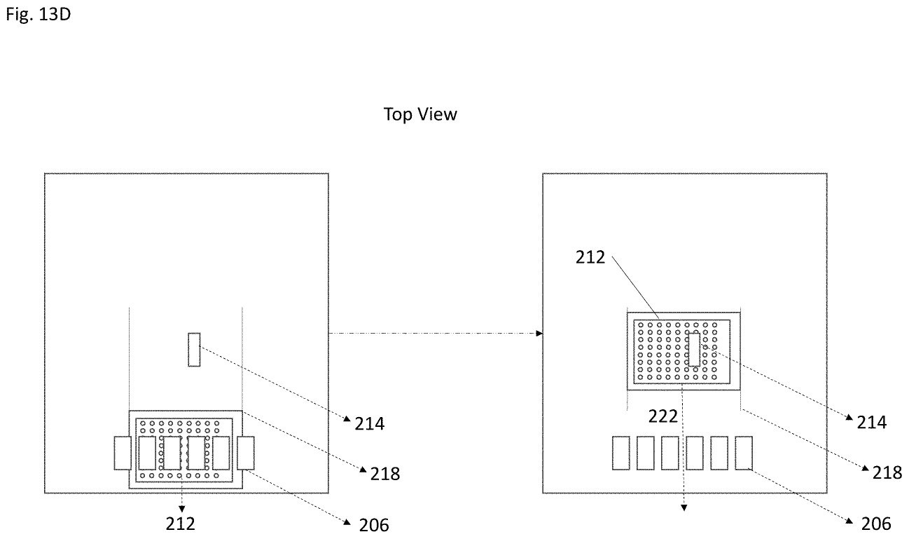

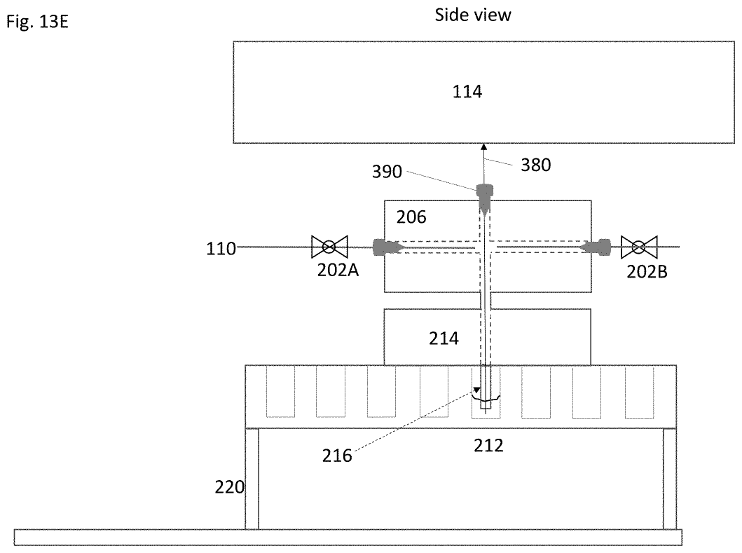

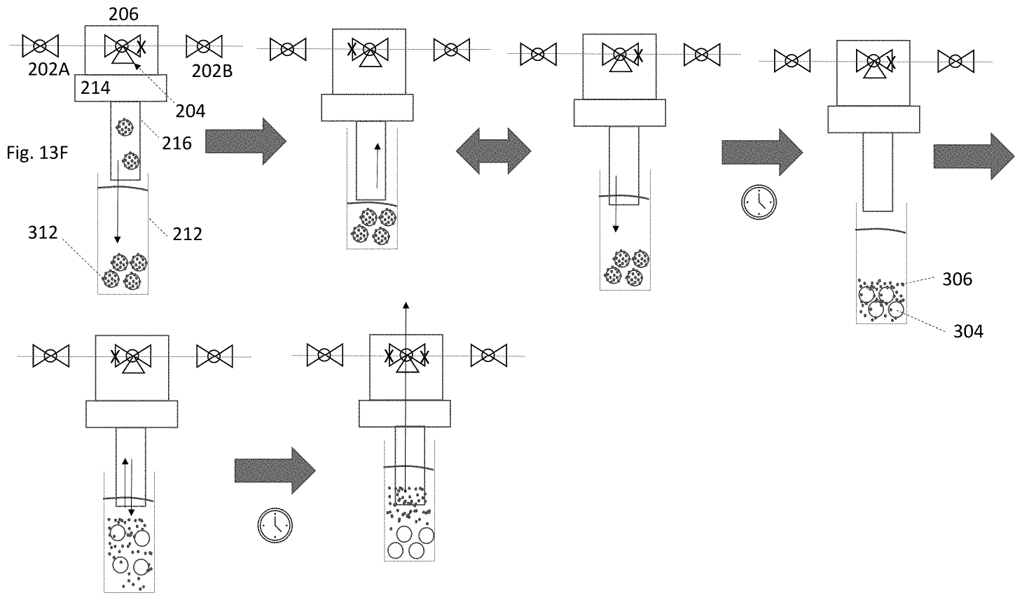

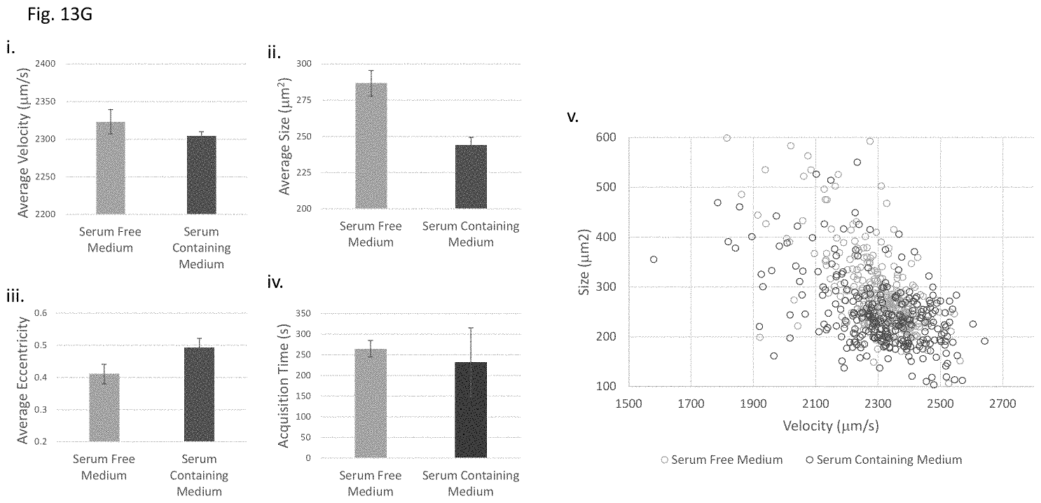

One embodiment of an instrument interface (115) is shown in FIGS. 13A-D, which demonstrate the sequence of steps of use thereof. In one embodiment shown in FIG. 13A, diluted sample from the dilution apparatus (110) travels through 3 valves (202A, 204, and 202B), the middle of which is contained with a dispensing manifold (206). While not sampling, the fluid stream from the dilution apparatus (110) goes to waste (112) during the constant flow process. The dispensing manifold has a dispensing needle or tube (208) that normally has its flow closed off by 3-way valve (204). The fluid stream from (110) may be mainly dilution fluid, in order to keep a constant flow of fluid through the device or to rinse out a previous sample. During sampling, the fluid stream from (110) will include the cells to be introduced into the analytical instrument (114). One embodiment of this is shown in FIG. 13B; valve (204) opens to the dispensing needle (208), while valve (202B) to waste closes, forcing the diluted sample from the dilution apparatus (110) to dispense into the well plate (212). In one embodiment, the dispensing manifold (206) might include or have attached its own pumping system such as pressure driven flow or a syringe, peristaltic, or diaphragm pump. The well plate (212) can be of any number of wells, such as 384, 192, 96, 48, 24, 12, or 6, and could be of custom or standard geometry. The well plate (212) would be placed on and held by a motion platform (218) that allows for 3-dimensional axis of motion. Once the specified volume of diluted sample is dispensed from the dilution manifold (206) into the individual well, the well plate via the motion platform, moves along a path (222) to the injection manifold (214) situated at the bottom of or below the analytical instrument (114) so that the injection needle (216) is submerged in that particular sample. FIG. 13C shows how the well plate moves to the injection location and that the motion platform incorporates a mechanism for vertical motion (220). The sample then proceeds into the analytical instrument (114) for measurement. After filling the sample into the well plate, valve (204) closes to the dispensing needle and valve (202B) opens to waste to resume constant flow process. Subsequent samples can be dispensed in a similar fashion to any of the locations within the well plate. The motion platform (218) enables any one of the wells in the plate to be addressed by both the dispensing manifold (206) and the injection manifold (214).

In a configuration with multiple bioreactors (for example wherein the number of bioreactors is N), there are a corresponding number of dispensing manifolds (206) (for example, wherein the number of dispensing manifolds is M), with M being the same or a different number than N, depending upon the configuration and setup. FIG. 13D shows a top view that demonstrates how multiple manifolds can be positioned in order to enable multiple samples from multiple manifolds to be filled either in series (one sample at a time into the well plate from one manifold), or in parallel (multiple samples at the same time from multiple manifolds into one or more well plates). FIG. 13D also shows a top view illustration of the movement path (222) of the well plate (212) by the motion platform (218) between the dispensing manifolds and the injection manifold (214).

The embodiments shown in FIGS. 13A-D may also include the use of multiple well plates. The present embodiment also includes the use of motion of any component, such as the various manifolds, well plates, and injection and dispensing needles as necessary for proper function and form of the continuous microfluidic sampling device.

The embodiments shown in FIGS. 13A-D depict two separate locations for the dispensing manifold (206) and the injection manifold (214). However, an alternate embodiment would combine them into a single connected location within (or outside) the analytical instrument, as shown in FIG. 13E. In this case, the sample would be drawn from the bioreactor and through the dispensing manifold into the well plate. The injection path or tubing (380) would travel from the analytical instrument, through both the dispensing manifold and injection manifold. As shown in FIG. 13E, one embodiment exists where the injection tubing is small enough to run through both the dispensing (206) and injection (214) manifolds, resulting in a direct flow path from the well plate to the analytical instrument. In other words, the fluid coming from the sides of the dispensing manifold (through valves 202A and 202B) would not contact the fluid in the injection tubing. This is critical as it maintains two discrete flow paths and allows for dispensing or removal of reagents from the well without disrupting the injection flow path for sample into the analytical instrument. Air-tight fittings or ports (390) can be attached as needed in order to create a seal or separate flows. The embodiment in FIG. 13E depicts two ports for reagents or samples to enter (shown on the left and right), in addition to the injection tubing (380), which travels through the top and bottom of the manifold in the illustrated embodiment. However, additional embodiments could exist with only one port in addition to the injection tubing, or greater than two ports in addition to the injection tubing, or could adjust the location of the injection or additional ports.

FIG. 13F depicts a sequence for introducing cells detached from microcarriers into the analytical instrument, using a combined dispensing manifold (206) and injection manifold (214), similar to the embodiment shown in FIG. 13E. In the first step, microcarriers with cells (312) attached are dispensed from the bioreactor (100) or other external source through the dispensing manifold and into the well plate (212). Subsequently, the microcarriers with cells are allowed to settle before the supernatant solution is removed. Then, a different solution is added through the dispensing manifold and into the well plate. Any number of aspiration and dispensing cycles can be run as needed, as shown by the bidirectional arrow in FIG. 13F. After these cycles are complete, a reagent designed to detach the cells is added to the well plate and incubated for a period of time. During this incubation, mixing can occur as needed. At the end of the incubation period, the cells (306) will be detached from the now uncoated/bare microcarriers (304). Subsequently, the combined solution can be mixed. After a brief settling period, the microcarriers will be located at the bottom of the well plate, but the cells will be well-mixed, given the large difference in settling velocity between the two species. This will allow the injection needle (216) to preferentially sample the cells but not the microcarriers. Although a valve is shown in FIG. 13F, other designs, or structures, such as the manifold described in FIG. 13E, could be used to preferentially direct and/or isolate various flow streams moving from the sampling vessel into the well plate and from the well plate to the analytical instrument.

FIG. 13G shows representative data collected on a RADIANCE® Laser Force Cytology instrument from a mixture of detached cells and microcarriers. Vero cells were grown on microcarriers in either serum-free or serum-containing medium. At the time of harvest, cells were manually detached from the microcarriers and then a mixture of the cells and microcarriers were loaded into a 96-well plate for analysis with RADIANCE®. FIG. 13Gi.-iv. show population wide averages of multiple wells for both media conditions in several RADIANCE® measurements, including velocity, size, and eccentricity, plus the average acquisition time to reach the target count of 300 cells. FIG. 13Gv. Shows a representative Size vs Velocity scatter plot for both media conditions. Each symbol represents the data from a single cell.

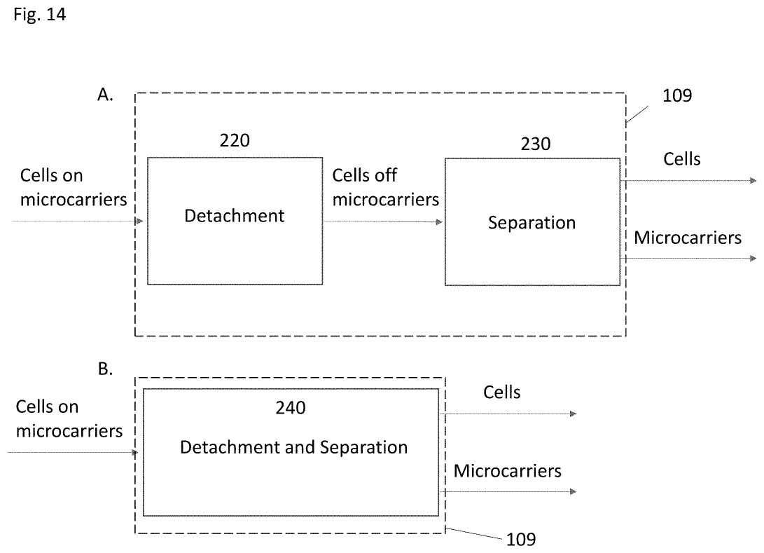

As a part of bioreactor sample handling procedures, the invention also includes a device necessary for microcarrier removal from cells (109), a schematic of one such embodiment which is shown in FIG. 14. This device can be used in conjunction with any of the embodiments of the sampling system described herein, or as a stand-alone device to aid the user in bioproduct analysis of samples in a bioreactor or purification. Schematics are shown for two embodiments of the device (FIG. 14(A) and FIG. 14(B). In both embodiments, the input to the device consists of cells attached to microcarriers, but in the first device the detachment of the cells from the microcarriers happens in a separate sub-device (220) from the physical separation of the detached cells and empty microcarriers into physically separate flow streams. Thus, the output of the detachment device (220) would be one stream of free cells interspersed with microcarriers. The output of the detachment sub-device (220) would then be the input of the separation sub-device (230), the output of which would then be cells in one channel or tube and microcarriers in another. In the second embodiment of the device, the detachment and separation occur in the same device (240), the output of which is cells in one channel or tube and microcarriers in another. In any microcarrier removal device embodiment, the mode of detachment of the cells from the microcarriers may be chemical, biochemical (such as with an enzyme such as trypsin or a similarly functional protease), mechanical, thermal, optical, electrical, or any combination thereof. Furthermore, the separation force that physically separates detached cells from microcarriers may be optical, gravitational, electrical, magnetic, fluidic, mechanical, or any combination thereof. In one embodiment used for sampling, the output stream of cells would ultimately be introduced into the analytical instrument (114). However, alternate embodiments could direct either the cell stream or microcarrier stream to any number of analysis, purification, or collection devices/instruments. In addition, multiple cell types could be included either co-cultured on the same microcarriers or cultured but on different microcarriers. In this situation, additional elements may be introduced to separate the detached cells based on size, density, dielectric potential, optical, magnetic, or other means.

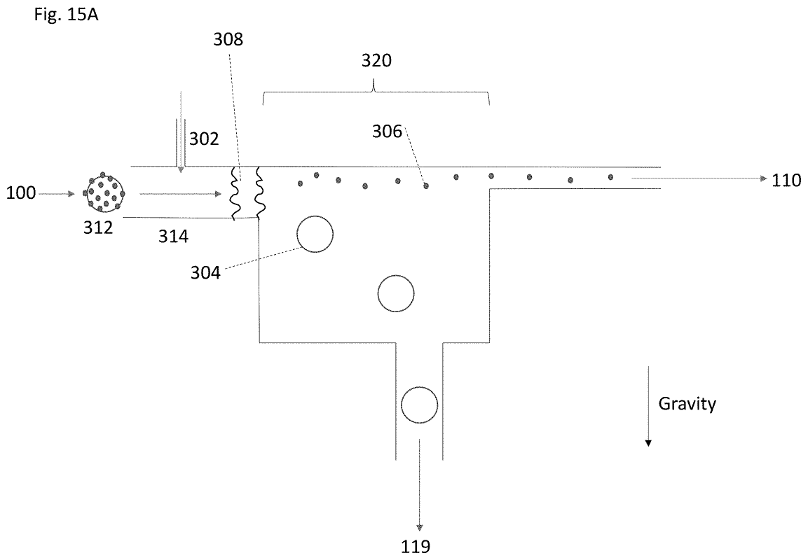

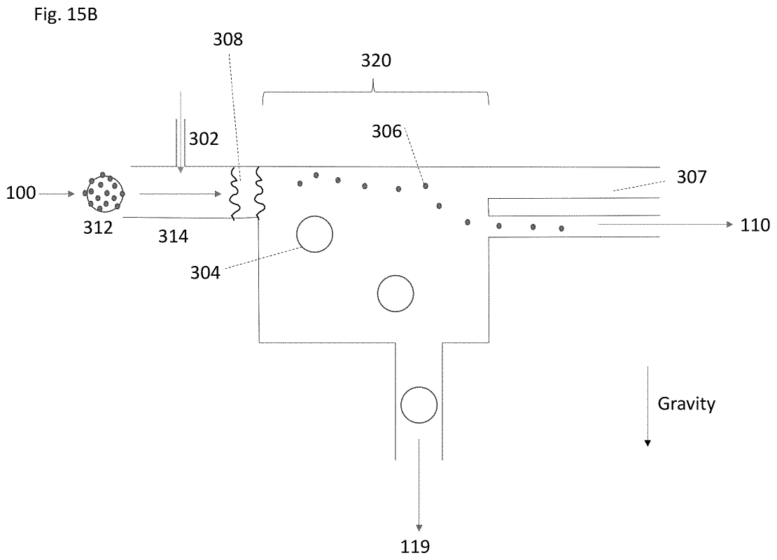

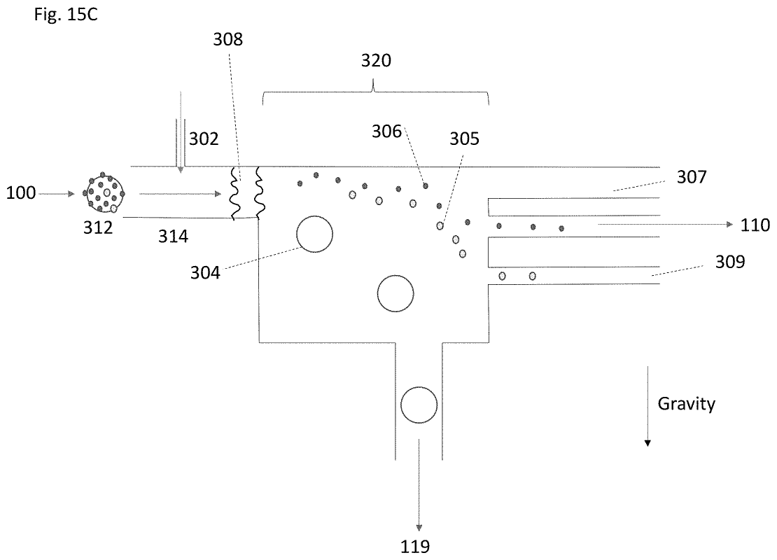

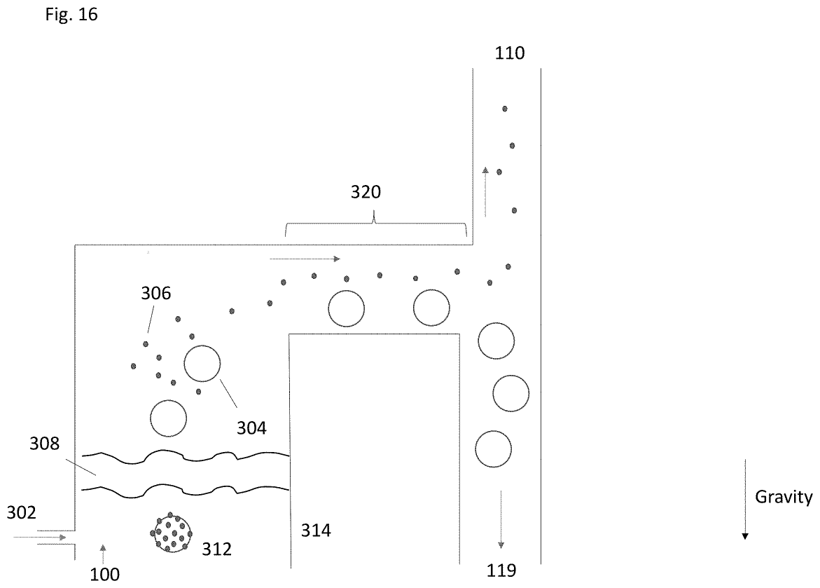

One specific embodiment of a combined microcarrier removal device is shown in FIG. 15A. The input of the device comprises microcarriers with cells or other bioproducts attached (312), from a bioreactor (100) or other source. The microcarriers (312) enter a removal chamber via a large introduction channel (314), wherein optionally trypsin, or any substance used for detachment and/or anti-adhesion, is introduced via a separate input (302). The microcarriers then travel through a reaction zone (308) in which the bioproduct separates from the microcarrier. The reaction zone (308) may be relatively longer or shorter than as represented in FIG. 15, the curved lines are meant to indicate this. The length and dimensions of the reaction zone (308) may be correlated to time, channel length, inertial focusing, or any combination thereof. Although shown horizontally in FIG. 15, the reaction zone could also be vertical (parallel with the direction of gravity) as shown in FIG. 16, or at an angle with respect to gravity, to facilitate the efficient detachment of cells. By the end of the reaction zone (308), most if not all of the cells/bioproduct (306) have been detached from the microcarriers (304) and are flowing together in the same channel. As they enter the separation chamber (320), the microcarriers (304) separate from the cells (306) due to their larger size. The dimensions of the chamber (320) are such that the microcarriers fall into a waste channel (119) as a result of their higher settling velocity, while the free cells move onto the dilution apparatus (110) or another separate device.

FIG. 15B shows another embodiment of a device, which includes an additional horizontal channel (307) that contains few or little cells, as the cells have also settled and move onto the dilution apparatus (110) or another separate device at a location lower that they entered.

FIG. 15C shows another embodiment, in which an additional cell type (305) that is different in character than (306) is grown on microcarriers along with (306). While FIG. 15C shows the cells grown together on the same microcarrier, it is also possible that they could be grown on completely separate microcarriers and the device would function in a similar manner. Cell type (305) could also be a subpopulation of (306), with different characteristics in some desirable way, such as increased production of a target product, or improved viability in a bioreactor. In this embodiment, one or more additional cell channels (309) are included in order to separate the multiple cell types and populations based on differences in settling velocity.

An additional embodiment is shown in FIG. 16, which includes a vertical reaction zone (308). In this embodiment, the separation chamber (320) is still horizontal, and is constructed such that the microcarriers (304) fall into a separate flowstream than the cells (306), which then allows them to be separated into different exit channels, which in this embodiment are microcarrier waste (119) and onto the dilution apparatus (110).

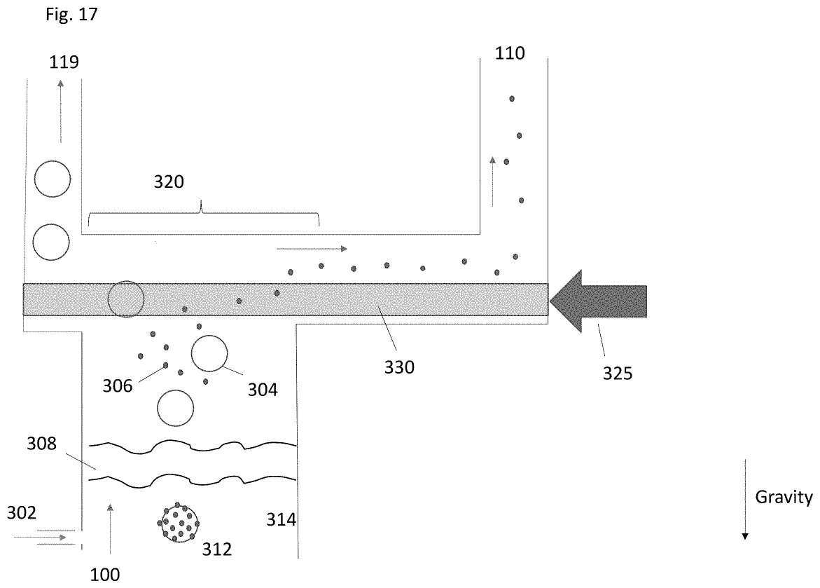

FIG. 17 shows another embodiment of the device, in which the reaction zone (308) is vertical, but as the separated cells (306) and microcarriers (304) enter the separation zone (320) an applied force (325) is used to preferentially push the microcarriers (304) into a separate fluidic stream and into the waste (119), while the free cells move onto the dilution apparatus (110) or another separate device. This separation occurs as cells (306) and microcarriers (304) pass through the force interaction zone (330) and experience the differential force. The illustrated embodiment shows an optical force, which creates a force interaction zone (330) based on the shape of the beam. However, the force could also be electrical, magnetic, fluidic, mechanical, or any combination thereof. As shown, the force (325) acts horizontally, opposing the fluid flow of the cells (306) and microcarriers (304) as they enter the separation zone (320). However, the force could also act on those species either before or as they are making the transition from vertical flow to horizontal, and thus the force (325) would be acting either orthogonally or at an angle.

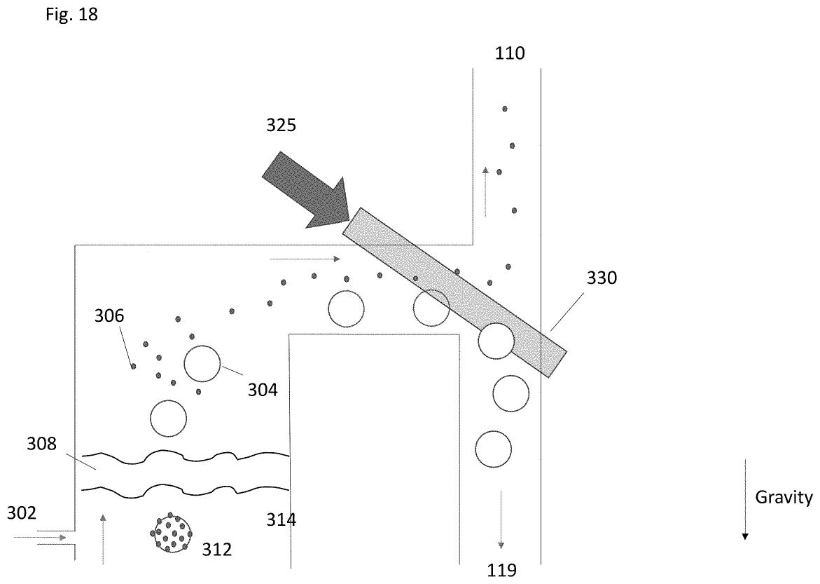

Another embodiment of this is shown in FIG. 18, in which the force (325) acts at an angle to but also in the direction of flow, pushing the microcarriers (304) down into a lower fluidic stream and subsequently out through the bottom of the chamber into the waste (119). In this embodiment, the angle can be varied as needed in order to maximize the efficiency of separation.

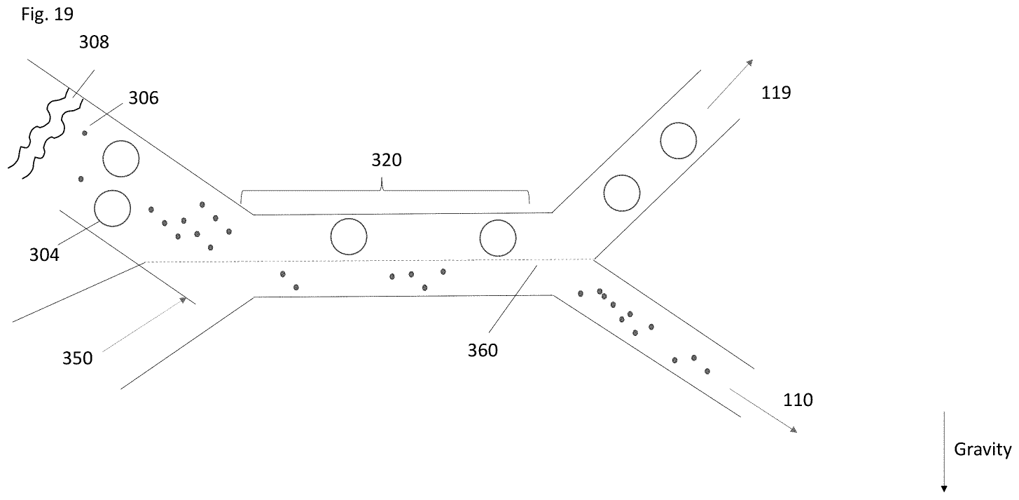

Another embodiment for the microcarrier separation device is shown in FIG. 19. Following the reaction zone (308), which may be either horizontal or vertical as previously described, free cells (306) and microcarriers (304) enter into the separation zone (320), where a fluid of higher density (350) is introduced from a lower channel that meets and combines with the upper channel carrying the cells (306) and microcarriers (304). The density of (350) will be higher than the density of the fluid the cells (306) and microcarriers (304) are traveling in, and due to density differences between the two, the higher density species (as illustrated this is the cells but in practice could be either the cells or microcarriers) drops below the density gradient (360), while the lower density species remains in the upper portion of the channel. After a specified length of channel that allows the separation to occur, the higher density species exits through the lower channel and the lower density species exits through the upper channel. As illustrated, the lower density microcarriers travel through to 119, while the higher density cells move onto the dilution apparatus (110) or another separate device. Although illustrated as a distinct interface, the density gradient may also be more continuous than discrete, depending upon the composition of the fluids as well as the geometry and operating conditions within the device.

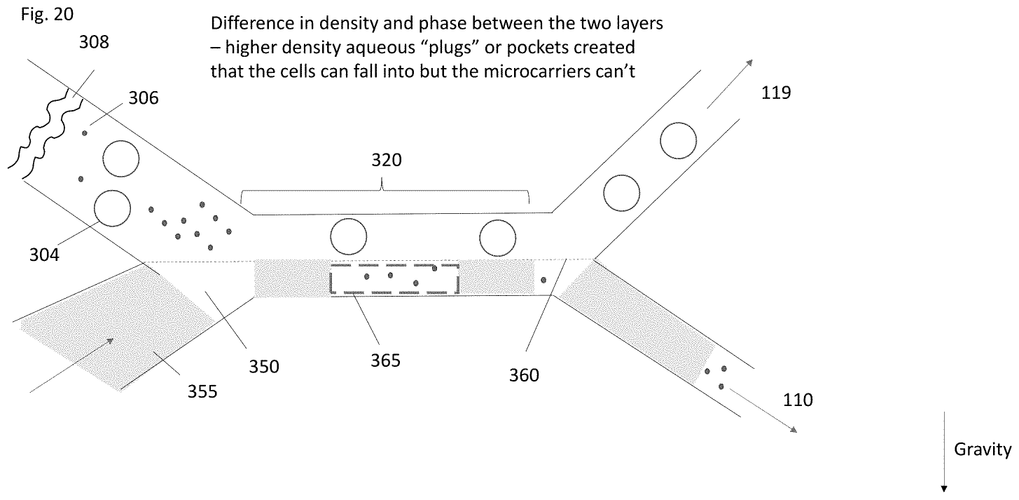

Another embodiment is shown in FIG. 20 that functions similarly to the device shown in FIG. 19. However, the higher density fluid (350) which is broken up into discrete plugs or droplets (365) by traveling through a high-density liquid of a separate phase, such as an oil or an aqueous two-phase system (ATPS). As the upper and lower channels of the device meet, the higher density fluid remains in discrete sections due to both density and phase differences, and the cells (306) are able to fall into the fluid plugs or droplets (365) but are prevented from entering (355) due to the phase differences. The size of the of the plugs or droplets (365) could also be tuned to be small enough to prevent the microcarriers (304) from also falling in due to size exclusion.

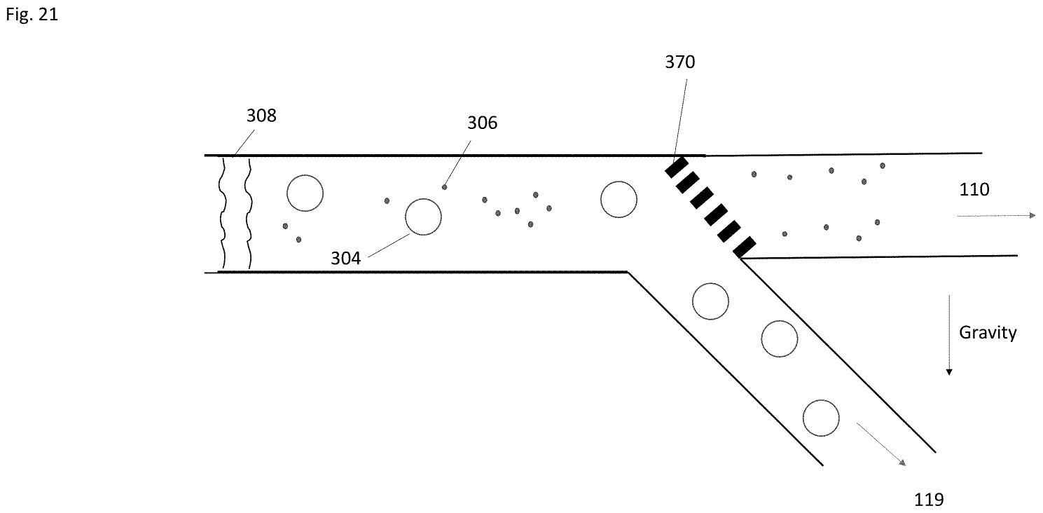

Another embodiment of a device for removing microcarriers from cells is shown in FIG. 21. Following the reaction zone (308), which may be either horizontal or vertical as previously described, free cells (306) and microcarriers (304) flow into a channel an encounter a selective barrier (370) that allows only the cells to pass through, based on size exclusion. This barrier could be a mesh or membrane with properly sized holes to allow the cells (306) to pass, or could also be a series of pillars or other physical barriers that are spaced in such a way as to only allows the cells (306) to pass through. The microcarriers (304) cannot move through the barrier due to their much larger size, and instead slide down the barrier due to settling and exit the device through the waste channel (119). The cells (306) move through the barrier (370) onto the dilution apparatus (110) or another separate device. The flow through the device may be continuous, or pulsatile in order to clear any microcarriers (304) that are stuck to the barrier (370).

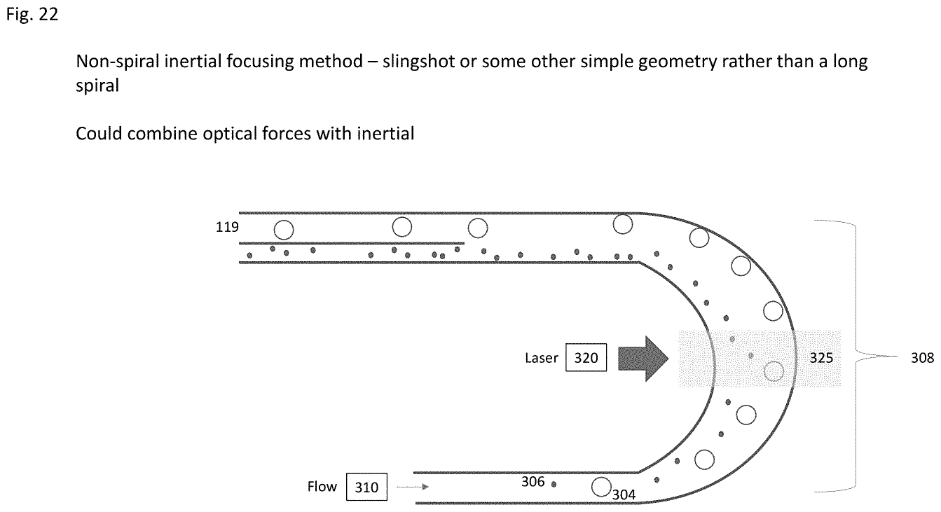

Another embodiment that can be used to separate the free cells (306) from the microcarriers (304) is shown in FIG. 22. Following the reaction zone (308), which may be either horizontal or vertical as previously described, free cells (306) and microcarriers (304) flow into a channel or series of channels designed to separate cells based on inertial forces generated as a result of the curvature of the channel and/or the shape of the channel cross section. As the channel turns, the microcarriers (304) will move into a different fluidic layer and can thus be separated into a separate channel that can flow to waste (119). The cells (306) will remain in a separate layer and move onto the dilution apparatus (110) or another separate device. The inertial forces could also be combined with a separate force, such as an optical by using a laser (320) with beam overlapping the channel (325), mechanical, magnetic, or electrical force, positioned in a way to improve the efficiency of the inertial separation and allow it to operate under a wider variety of flow conditions.

Provided herein are novel systems and methods for the preparation of biological samples for analysis comprising the steps of: obtaining a sample from a vessel, processing the sample, and transporting the sample to an analysis instrument. The system comprises a means for extracting a sample from a vessel, one or more control valves, one or more reagent addition, dilution or concentration mechanisms, one or more mixing mechanisms, and an analysis instrument interface.

The novel systems and methods may be used for the assessment of biological samples including, but not limited to, cells, cellular fragments, cellular components, viruses, bacteria, microbes, pathogens, macromolecules, sugars, genetic material, nucleic acid, DNA, RNA, transcription factors, amino acids, peptides, proteins, lipids, enzymes, metabolites, antibodies, or receptors. As contemplated herein, the vessels from which the biological samples are removed are known to those skilled in the art and include, bioreactors, flasks, bottles, test tubes, slides, bags, microtiter plates, microtiter dishes, multi-well plates, culture dishes, permeable supports and the like. In various embodiments, the analysis instrument may comprise a laser force analytical instrument, sequencing instrument, PCR analysis instrument, high performance gas or liquid chromatography (HPLC) or a mass spectrometry (MS) machine; in certain specific embodiments, the analysis instrument comprises a RADIANCE® machine (LumaCyte, LLC. Virginia USA). Additional features of the systems include a sample extraction apparatus comprising a sterile dip tube and/or microcarrier separation device. As known to those skilled in the art, microcarriers are support matrices that allow for the growth of adherent cells/biological particles in bioreactors; the systems described herein enable the separation of adherent cells/biological particles from a microcarrier comprising the use of fluidic, enzymatic, biological, chemical, electrical, magnetic, thermal, optical, mechanical or gravitational methods. In certain embodiments, microcarriers are separated from the biological particles by various methods including but not limited to: gravitationally in a horizontal channel, due to density differences between the cells using fluids of varying density, using an active force in a vertical channel with various exit locations, using an active force in a horizontal channel with various exit locations, based on size using a mesh, angled mesh, pillars, or other structures, wherein the flow is continuous or pulsatile, and/or based on size using inertial fluidic forces or inertial plus others (optical or electrical for example) to improve efficiency of separation.

The systems and methods contemplated herein allow for the processing of biological particles from other sample components, enabling purification, decontamination, enrichment and chemical modification.

As contemplated herein, the biological samples are transported from the vessel to the analysis instrument using pressure or vacuum driven flow, pumping via a peristaltic pump, syringe pump, or diaphragm pump, the direction of flow may be determined by mechanisms known to those skilled in the art, including for example valve configurations, and/or tubing.

Sampling may be continuous or segmented, and in certain embodiments, the systems may comprise multiplex systems consisting of sampling systems wherein samples are obtained from more than one bioreactors.

In certain embodiments, diluting, mixing, and interface occur in the same device.

In certain embodiments, the systems and methods contemplated herein comprise one or more features enabling monitoring with feedback for process control using a control system.

Additional features of certain embodiments include microfluidic T mixing and dilution devices with microfluidic channels; such embodiments may further comprise a configuration of base t, offset t, t's in parallel, t's with multiple discrete inputs, t's with multiplex inputs that combine into one.

In certain embodiments, the systems and methods further comprise a sampling manifold chip/cup and interface to autosampler (and variations).

As used herein, the term biological particle includes, but is not limited to cells, cellular fragments, cellular components, viruses, bacteria, microbes, pathogens, macromolecules, sugars, genetic material, nucleic acid, DNA, RNA, transcription factors, amino acids, peptides, proteins, lipids, enzymes, metabolites, antibodies, receptors, analytes of interest, and the like. Biological samples include specimens derived from living organisms, such as not, but not limited to blood, urine, tissues, organs, saliva, DNA/RNA, hair, nail clippings, or any other cells or fluids-whether collected for research purposes or as residual specimens from diagnostic, therapeutic, or surgical procedures

As used herein, the term “microfluidic channel” includes an opening, orifice, gap, conduit, passage, chamber, or groove in an apparatus, where the microfluidic channel is of sufficient dimension that allows passage or analysis of one or more biological particles.

As used herein, reagents and solutions suitable for use with the invention include any substances that are necessary for analyzing and processing biological samples. Examples of such reagents and solutions include, but are not limited to enzymes, fluorophores, oligonucleotides, primers, barcodes, buffers, deoxynucleotide triphosphates, detergents, lysis agents, reducing agents, chelating agents, oxidizing agents, nanoparticles, antibodies, enzymes, temperature-sensitive enzymes, pH-sensitive enzymes, light-sensitive enzymes, reverse transcriptase, proteases, ligase, polymerases, restriction enzymes, transposase, nucleases, protease inhibitors, and nuclease inhibitors.

As will be appreciated, the channel and/or connecting segments described herein may be coupled to any of a variety of different fluid sources or receiving components, including reservoirs, tubing, manifolds, or fluidic components of other systems. In addition, channel structures may have varying geometries: for example, a microfluidic channel structure can have more than one channel junction, a microfluidic channel structure can have 2, 3, 4, or 5 (or more) channel segments. Furthermore, fluid may be directed flow along one or more channels or reservoirs via one or more fluid flow units. A fluid flow unit can comprise compressors (e.g., providing positive pressure), pumps (e.g., providing negative pressure), actuators, and the like to control flow of the fluid. Fluid may also or otherwise be controlled via applied pressure differentials, centrifugal force, electrokinetic pumping, vacuum, capillary or gravity flow, or the like.

1. A system for preparing a biological sample for analysis comprising the steps of:
a. obtaining the sample from a vessel,
b. processing the sample, and
c. transporting the sample to an analysis instrument,
wherein the system comprises:
a means for extracting a sample from a vessel,
one or more control valves,
one or more reagent addition, dilution or concentration mechanisms,
one or more mixing mechanisms,
and an analysis instrument interface.

2. The system of claim 1, wherein the biological sample comprises: cells, cellular fragments, cellular components, viruses, bacteria, microbes, pathogens, macromolecules, sugars, genetic material, nucleic acid, DNA, RNA, transcription factors, amino acids, peptides, proteins, lipids, enzymes, metabolites, antibodies, or receptors.

3. The system of claim 1, wherein the vessel comprises bioreactors, flasks, bottles, test tubes, slides, bags, microtiter plates, microtiter dishes, multi-well plates, culture dishes, or permeable supports.

4. The system of claim 1, wherein the analysis instrument comprises a laser force analytical instrument, sequencing instrument, PCR analysis instrument, high performance gas or liquid chromatography (HPLC) or a mass spectrometry (MS) machine.

5. The system of claim 4, wherein the analysis instrument comprises a RADIANCE® instrument.

6. The system of claim 1, wherein the sample extraction apparatus comprises a sterile dip tube.

7. The system of claim 1, further comprising a microcarrier separation device.

8. The system of claim 7, wherein the microcarrier separation device is capable of separating a biological particle from a microcarrier comprising the use of fluidic, enzymatic, biological, chemical, electrical, magnetic, thermal, optical, mechanical or gravitational methods.

9. The system of claim 1, wherein processing the sample comprises separation of biological particles from other sample components, purification, enrichment and chemical modification.

10. The system of claim 1, further comprising the step of decontamination.

11. The system of claim 1, wherein the sample is transported from the vessel to the analysis instrument using pressure or vacuum driven flow, pumping via a peristaltic pump, syringe pump, or diaphragm pump.

12. The system of claim 11, wherein the direction of flow is further determined by valve configurations, and tubing.

13. The system of claim 1, wherein the sampling is continuous or wherein the sampling is segmented.

14. The system of claim 1, wherein the system is a multiplex system comprising a sampling system wherein samples are obtained from more than one bioreactors.

15. The system of claim 2, wherein the diluting, mixing, and interface occur in the same device.

16. The system of claim 1, further comprising one or more features enabling monitoring with feedback for process control using a control system.

17. The system of claim 1, further comprising a microfluidic T mixing and dilution device with microfluidic channels.

18. The system of claim 17 comprising base t, offset t, t's in parallel, t's with multiple discrete inputs, t's with multiplex inputs that combine into one.

19. The system of claim 1, further comprising a sampling manifold chip/cup and interface to autosampler (and variations).

20. The system of claim 8, wherein microcarriers are separated from the biological particles gravitationally in a horizontal channel.

21. The system of claim 8, wherein microcarriers are separated from the biological particles due to density differences between the cells using fluids of varying density.

22. The system of claim 8, wherein microcarriers are separated from the biological particles using an active force in a vertical channel with various exit locations.

23. The system of claim 8, wherein microcarriers are separated from the biological particles using an active force in a horizontal channel with various exit locations.

24. The system of claim 8, wherein microcarriers are separated from the biological particles based on size using a mesh, angled mesh, pillars, or other structures, wherein the flow is continuous or pulsatile.

25. The system of claim 8, wherein microcarriers are separated from the biological particles based on size using inertial fluidic forces or inertial plus others (optical or electrical for example) to improve efficiency of separation.
